(19) United States
(12) Patent Application Publication
(10) Pub. No.: US 2025/0173605 A1
(43) Pub. Date: May 29, 2025

(54) COMPUTER SYSTEM STATUS DETECTION AND MANAGEMENT INCLUDING ARTIFICIAL INTELLIGENCE (AI) MODEL IMPROVEMENT USING TRUSTWORTHY AI

(71) Applicant: INTERNATIONAL BUSINESS MACHINES CORPORATION, ARMONK, NY (US)

(72) Inventors: MING QIAO SHANG GUAN, BEIJING (CN); Mai Zeng, Shi Jing Shan (CN); Sheng Yan Sun, Beijing (CN); Xin Xin Dong, Beijing (CN); Wei Song, Beijing (CN); Wen Zhong Liu, Beijing (CN); Kieron Dirk Anthony Hinds, Poughkeepsie, NY (US)

(21) Appl. No.: 18/522,993

(22) Filed: Nov. 29, 2023

(51) Int. Cl. G06N 20/00

(52) U.S. Cl. CPC G06N 20/00

(57) ABSTRACT

A computer-implemented method automatically enhancing model robustness and accuracy associated with a specified artificial intelligence (AI) model. The method may include automatically identifying model information associated with each of the AI models in the AI-based computer system, wherein automatically identifying the model information further comprises identifying a status of model results for the AI models. The method may also include automatically identifying the one or more subsystems related to the specified AI model. The method may further include, based on the identification of the related one or more subsystems, automatically identifying one or more important subsystems to the specified AI model. The method may also include, based on the one or more important subsystems, automatically revising the status of a model result of the specified AI model according to model revision rules. The method may also include generate a system status interpretability report for the specified AI model.

### BACKGROUND

The present invention relates generally to the field of computing, and more specifically, to automatically enhancing model robustness and accuracy associated with a specified artificial intelligence (AI) model among AI models in an AI-based computer system.

Generally, modern software systems generate a tremendous amount of data. Over the years, with the advancements in computing infrastructure, this data has been fueled by Artificial Intelligence (AI), in particular, Machine Learning (ML) and ML models, to generate actionable insights and further pave the way for developing software systems and services. For example, a ML-based system may include ML models that are deployed throughout different subsystems and developed through different processes but still have dependency amongst each other. However, the increasing adoption of AI, particularly ML, has given rise to different challenges associated with development practices, deployments, and ensuring data quality in addition to the challenges of a traditional software system. For example, during a system's daily operation, a check may need to be performed on the system's status to ensure operational integrity. These challenges call for better architecting practices for addressing the concerns of AI-based software systems. Some of these challenges may be resolved using AI, whereby AI-based systems that thrive on data may use AI to better their architecting practices.

### SUMMARY

A method for automatically enhancing model robustness and accuracy associated with a specified artificial intelligence (AI) model among AI models in an AI-based computer system is provided. The method may include automatically identifying model information associated with each of the AI models in the AI-based computer system, wherein automatically identifying the model information further comprises identifying a status of model results for the AI models. The method may also include automatically identifying the one or more subsystems related to the specified AI model, wherein each of the related one or more subsystems comprise one or more of the AI models. The method may further include, based on the identification of the related one or more subsystems, automatically identifying one or more important subsystems to the specified AI model, wherein automatically identifying the one or more important subsystems further comprises using a trained question-answering model to calculate a score for each of the related one or more subsystems, and identifying the related one or more subsystems having the calculated score at or above a threshold score as the one or more important subsystems. The method may also include, based on the one or more important subsystems and the model results of the AI models associated with the one or more important subsystems, automatically revising the status of a model result of the specified AI model according to model revision rules. The method may also include generate a system status interpretability report for the specified AI model.

A computer system for automatically enhancing model robustness and accuracy associated with a specified artificial intelligence (AI) model among AI models in an AI-based computer system is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include automatically identifying model information associated with each of the AI models in the AI-based computer system, wherein automatically identifying the model information further comprises identifying a status of model results for the AI models. The method may also include automatically identifying the one or more subsystems related to the specified AI model, wherein each of the related one or more subsystems comprise one or more of the AI models. The method may further include, based on the identification of the related one or more subsystems, automatically identifying one or more important subsystems to the specified AI model, wherein automatically identifying the one or more important subsystems further comprises using a trained question-answering model to calculate a score for each of the related one or more subsystems, and identifying the related one or more subsystems having the calculated score at or above a threshold score as the one or more important subsystems. The method may also include, based on the one or more important subsystems and the model results of the AI models associated with the one or more important subsystems, automatically revising the status of a model result of the specified AI model according to model revision rules. The method may also include generate a system status interpretability report for the specified AI model.

A computer program product for automatically enhancing model robustness and accuracy associated with a specified artificial intelligence (AI) model among AI models in an AI-based computer system is provided. The computer program product may include one or more computer-readable storage devices and program instructions stored on at least one of the one or more tangible storage devices, the program instructions executable by a processor. The computer program product may include program instructions to automatically identify model information associated with each of the AI models in the AI-based computer system, wherein automatically identifying the model information further comprises identifying a status of model results for the AI models. The computer program product may include program instructions to automatically identify the one or more subsystems related to the specified AI model, wherein each of the related one or more subsystems comprise one or more of the AI models. The computer program product may include program instructions to, based on the identification of the related one or more subsystems, automatically identify one or more important subsystems to the specified AI model, wherein automatically identifying the one or more important subsystems further comprises using a trained question-answering model to calculate a score for each of the related one or more subsystems, and identifying the related one or more subsystems having the calculated score at or above a threshold score as the one or more important subsystems. The computer program product may include program instructions to, based on the one or more important subsystems and the model results of the AI models associated with the one or more important subsystems, automatically revise the status of a model result of the specified AI model according to model revision rules. The method may also include generate a system status interpretability report for the specified AI model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to one embodiment;

FIG. 2 is a diagram illustrating system components of a system status identification and model improvement program for automatically enhancing model robustness and accuracy associated with a specified artificial intelligence (AI) model among AI models in an AI-based computer system according to one embodiment;

FIG. 3 is an operational flowchart for a program for automatically enhancing model robustness and accuracy associated with a specified artificial intelligence (AI) model among AI models in an AI-based computer system according to one embodiment;

FIG. 4 is an illustration of AI model output table according to one embodiment;

FIG. 5 are model information tables including model configuration files and a feature importance table;

FIG. 6 is an operational flowchart for identifying and calculating subsystems of importance for a specified AI model;

FIG. 7 is an illustration of a flowchart for generating a subsystem importance table according to one embodiment; and

FIG. 8 is an operational diagram for generating a system status interpretability report according to one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to automatically improving/enhancing model robustness and accuracy associated with a specified artificial intelligence (AI) model among AI models in an AI-based computer system, wherein enhancing the model robustness and accuracy may further include identifying subsystems of a determined importance to the specified AI model that may have an impact on the specified AI model and model results, revising a status of the model results of the specified AI model based on the subsystems of the determined importance, and generating a system status interpretability report detailing a runtime status of the AI models and the model results. Therefore, the present invention may improve the technical field associated with model-based computer systems by ensuring trustworthiness of AI models in the model-based computer system by further automatically and continuously checking a runtime status of AI models, revising an AI model result according to related subsystems to enhance the model robustness and accuracy of the AI model, and creating a report for the AI model detailing and interpreting system and model status.

As previously described, an AI-based system may include different AI/ML models that may be deployed throughout different subsystems and developed through different processes but still have dependency amongst each other. Each model may be trained by different features. For example, a transaction delay status model may use CPU utilization, transaction rate, number of servers, etc., as training features, while an I/O health model may use CPU utilization, I/O queue, and available channels as training features. However, during an AL-based computer system's daily operation, a check may need to be performed on the system's status to ensure operational integrity.

For example, model robustness and accuracy are critical factors in model performance, maintenance, and security. More specifically, for example, when building a model such as a computer vision model to determine whether an image includes fruit, the computer vision model may be trained on thousands of pictures and may perform well at recognizing apples, bananas, oranges, and other fruits that commonly appear. But what happens when the computer vision model is shown more unusual fruit, like a kiwi, a pomegranate, or a durian? Could the computer vision model recognize the images as fruits, even if the computer vision model does not know the specific type? Accordingly, a robust model will continue to make accurate predictions even when faced with challenging situations. For instance, model robustness ensures that a model can generalize well to new unseen data. Robust models may also perform more consistently in real-world scenarios where data may be noisy, unexpected, or contain variations.

Furthermore, as previously described, AI models may be widely used in monitoring a system's status as well as model prediction results. For example, a subsystem's and/or model's results may be analyzed and assigned a status, such as when the model results may be assigned a status of RED for indicating low accuracy and/or performance by a model, YELLOW for indicating a moderate accuracy and/or performance by the model, or GREEN for indicating a high accuracy and/or performance by a model. Accordingly, when there is a certain or threshold number of recorded inaccuracies associated with model results (indicative of a RED status for an overall performance of the model), efforts may be required to investigate a root cause of the subsystem's and/or model's poor performance or failure, and a subsystem's and/or model's failure may be due to or impacted by related subsystems and/or models. For example, when there is an abnormal memory usage by a database that is detected by a database model which is assigned to monitor memory usage, this could be because of a spike in transactions or processing of transactions by an input/output (I/O) component which may be monitored by an input/output (I/O) model. As such, efforts may need to be taken to determine a root cause of an issue associated with a specified model, and more specifically, determining the impact other related and important subsystems and models may have on a specific model. Accordingly, it may be advantageous, among other things, to improve system status interpretability and model robustness with trustworthy AI. As previously described with regard to model robustness, a more robust model may be better equipped to continue to make accurate predictions even when faced with challenging situations. Thus, when a subsystem and/or model encounters one or more discrepancies/problems, the present invention may enhance/improve model robustness and accuracy by identifying subsystems of a determined importance to the specified AI model that may have an impact on the specified AI model and model results, revising a status of the model results of the specified AI model based on the subsystems of the determined importance, and generating a system status interpretability report detailing a runtime status of the AI models and model results.

Accordingly, the present invention provides a method, computer system, and computer program product for automatically enhancing/improving model robustness and acuracy associated with a specified artificial intelligence (AI) model. Specifically, the method, computer system, and computer program product may automatically identify model information associated with each of the AI models in the AI-based computer system, wherein automatically identifying the model information further includes identifying a status of model results associated with the AI models. Then, the method, computer system, and computer program product may, for the specified AI model, and based on the model information for each of the AI models, automatically identify one or more subsystems related to the specified AI model, wherein each of the related one or more subsystems includes one or more of the AI models. Thereafter, based on the identification of the related one or more subsystems, the method, computer system, and computer program product may identify one or more important subsystems to the specified AI model, wherein identifying the one or more important subsystems further comprises using a trained question-answering model to calculate a score for each of the related one or more subsystems, and identifying the related one or more subsystems having a calculated score at or above a threshold score as the one or more important subsystems. Next, based on the one or more important subsystems and the model prediction results of the AI models associated with the one or more important subsystems, the method, computer system, and computer program product may revise the model results of the specified AI model based on model revision rules, wherein the revising is performed in response to a determination that a percentage of the AI models associated with the one or more important subsystems exceed a threshold percentage indicating a number of the AI models having a discrepancy in the model results. Thereafter, the method, computer system, and computer program product may generate a system status interpretability report for the specified AI model, wherein the system status interpretability report identifies the specified AI model, the one or more important subsystems and the AI models related to the specified AI model, and a status of each of the model results.

As such, the present invention may manage AI models and model features, identify abnormalities associated with the AI models, identify and extract high relative subsystems for a specified AI model, revise a status of model results based on the high relative subsystems to enhance robustness and accuracy of the specified AI model, and generate a system status interpretability report for the specified AI model.

The present invention may be a system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer program product and computer readable storage medium, as those terms are used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine whether directional input is received along with a query and, accordingly, adjust presented display content to include a referenced object in a center of a screen of a primary device.

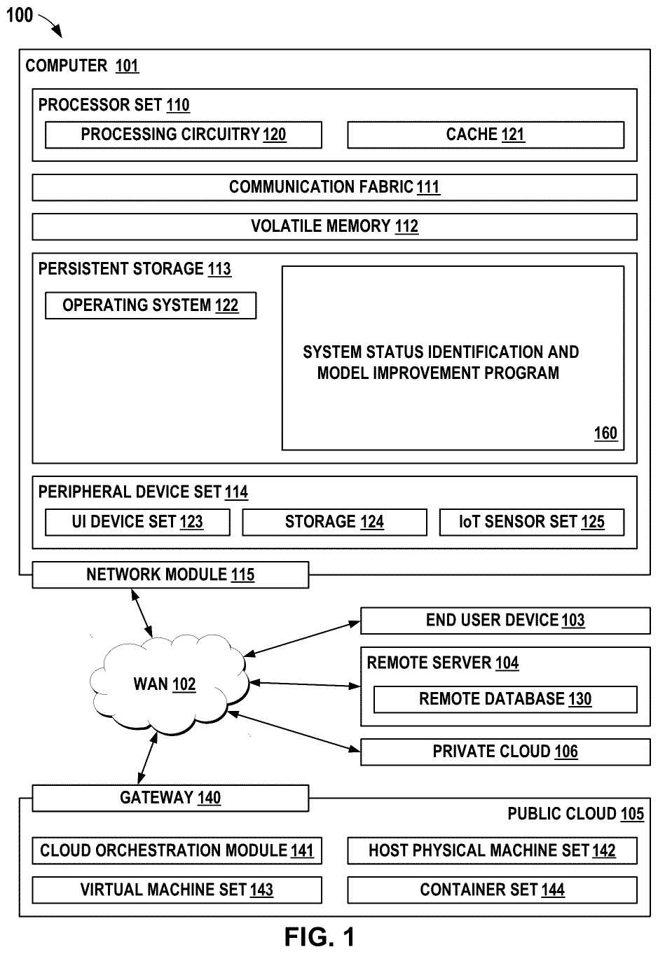

Referring to FIG. 1, an exemplary computing environment 100 is depicted, according to at least one embodiment. Computing environment 100 contains an example of an environment for the execution of at least some of the computer code involved in performing the inventive methods, such as a system status identification and model improvement program 160. In addition to block 160, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 160, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer (such as a wearable headset), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 160 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 160 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles, headsets, and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector and/or accelerometer.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

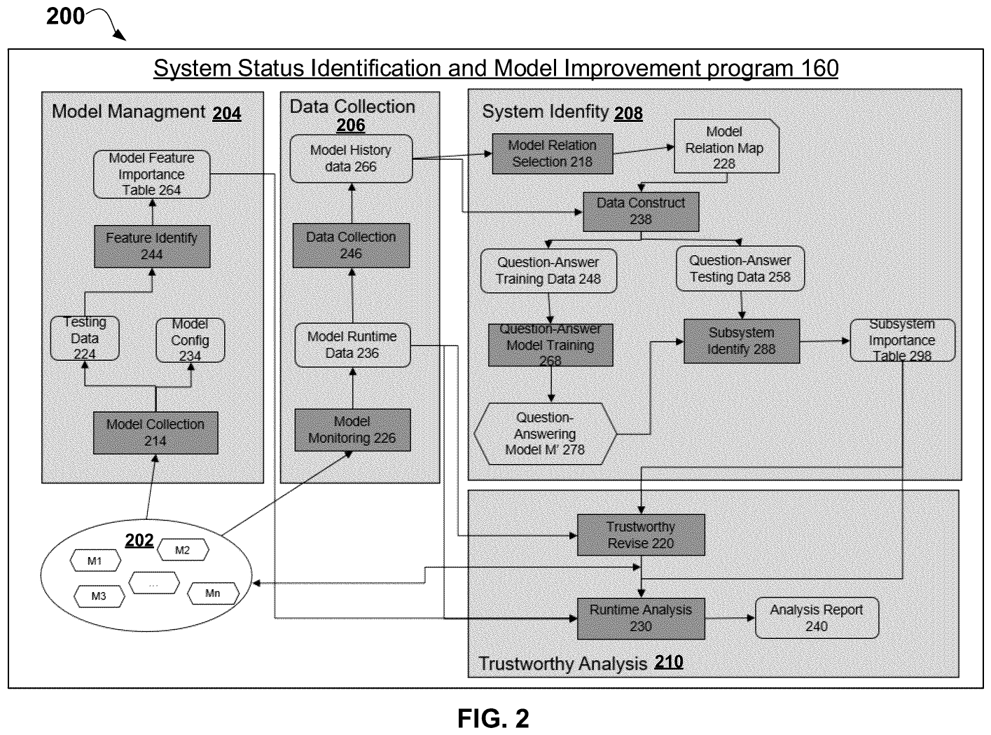

Furthermore, notwithstanding depiction in computer 101, the system status identification and model improvement program 160 may be stored in and/or executed by, individually or in any combination, with end user device 103, remote server 104, public cloud 105, and private cloud 106. The system status identification and model improvement program is explained in further detail below with respect to FIGS. 2-8.

According to the present embodiment, and as previously described, the system status identification and model improvement program 160 may be a program/code capable of automatically enhancing/improving model robustness associated with a specified artificial intelligence (AI) model. Specifically, the system status identification and model improvement program 160 may automatically identify model information associated with each of the AI models in the AI-based computer system, wherein automatically identifying the model information further includes identifying a status of model results associated with the AI models. Then, the system status identification and model improvement program 160 may, for the specified AI model, and based on the model information for each of the AI models, automatically identify one or more subsystems related to the specified AI model, wherein each of the related one or more subsystems includes one or more of the AI models. Thereafter, based on the identification of the related one or more subsystems, the system status identification and model improvement program 160 may identify one or more important subsystems to the specified AI model, wherein identifying the one or more important subsystems further comprises using a trained question-answering model to calculate a score for each of the related one or more subsystems, and identifying the related one or more subsystems having a calculated score at or above a threshold score as the one or more important subsystems. Next, based on the one or more important subsystems and the model prediction results of the AI models associated with the one or more important subsystems, the system status identification and model improvement program 160 may revise the model results of the specified AI model based on model revision rules, wherein the revising is performed in response to a determination that a percentage of the AI models associated with the one or more important subsystems exceed a threshold percentage indicating a number of the AI models having a discrepancy in the model results. Thereafter, the system status identification and model improvement program 160 may generate a system status interpretability report for the specified AI model, wherein the system status interpretability report identifies the specified AI model, the one or more important subsystems and the AI models related to the specified AI model, and a status of each of the model results.

Referring now to FIG. 2, a diagram 200 illustrating system components of the system status identification and model improvement program 160 according to one embodiment is depicted. As previously described, the system status identification and model improvement program 160 may improve artificial intelligence (AI)-based computer systems by automatically improving/enhancing model robustness and accuracy associated with a specified artificial intelligence (AI) model among AI models in the AI-based computer system, whereby enhancing/improving the model robustness and accuracy may include, in part, identifying subsystems of a determined importance to the specified AI model that have an impact on the specified AI model and model results, revising a status of the model results of the specified AI model based on the subsystems of the determined importance, and generating a system status interpretability report detailing a runtime status of the AI models and model results. Accordingly, the system status identification and model improvement program 160 may include different components and subcomponents with each including program/code for executing different computer operations/instructions described herein for automatically improving/enhancing model robustness and accuracy associated with a specified AI model.

Specifically, the system status identification and model improvement program 160 may include different AI models 202 (M1 . . . . Mn), whereby each AI model may be associated with a subsystem within the AI-based computer system. Specifically, according to one embodiment, each subsystem may include different AI models, and each AI model may be tasked with managing, analyzing, and/or performing different computer tasks/operations in a computer system. For example, an AI model may include a transaction delay status model which may use as model training features a CPU utilization rate of a computer system, transaction rate, and number of servers to, in turn, manage computer transactions. A database (DB) health model may manage the status and health of one or more databases. An input/output (IO) health model may use CPU utilization, IO queue, and available channels as training features to, in turn, manage and perform input/output operations.

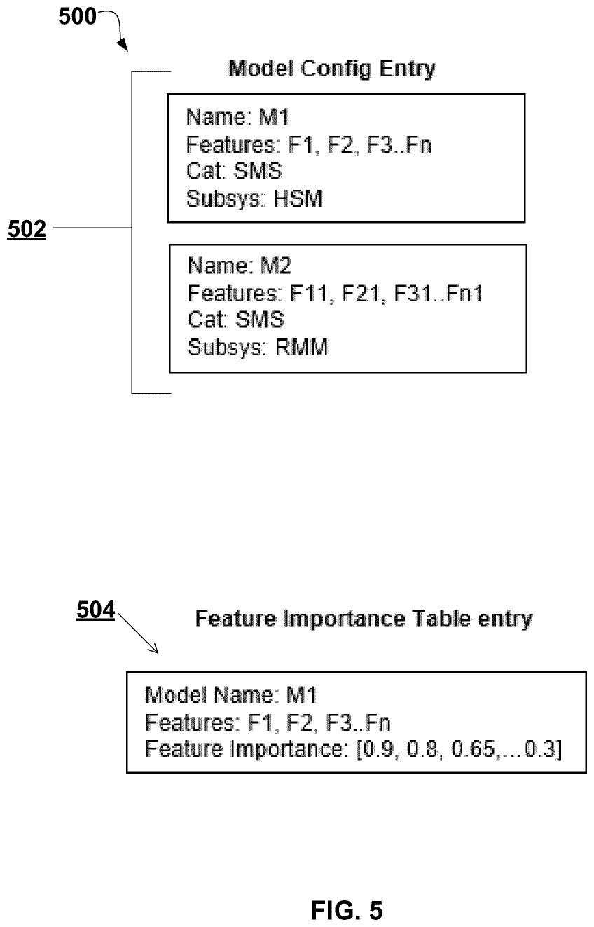

As further depicted in FIG. 2, the system status identification and model improvement program 160 may further include a model management component 204. The model management component 204 may identify and manage the different AI models' information, features, and status. As further depicted in FIG. 2, the model management component 204 may include different subcomponents. For example, the model management component 204 may include a model collection subcomponent 214 for identifying model information associated with the AI models in the AI-based computer system, whereby the model information may include model configuration data 234 and testing data 224 for a respective AI model. For example, according to one embodiment, the model configuration data may include a model configuration file which may further include information on an AI model including the features used for training the model and other information that may assist in identifying related AI models for a model relation map. For example, and with reference to FIG. 5, model information tables 500, and more specifically model configuration files 502, a model configuration file may include model name, features, model category, and subsystem data. Model collection subcomponent 214 may also identify testing data 224 that may include data used for testing a respective AI model, whereby the test data may also be used to identify and calculate feature importance. More specifically, feature identify subcomponent 244 may use the testing data 224 to calculate feature importance for each model and then may generate a model feature importance table 264 that includes the features and the calculated feature importance. The system status identification and model improvement program 160 may use known methods for calculating feature importance. As depicted in the model information tables 500 in FIG. 5, and specifically in feature importance table 504, the model configuration file may contain information on an AI model (M1), including model name, features, and feature importance.

Data collection component 206 may monitor AI model runtime data (real-time performance and model output) and create model history data for each AI model based on the respective model runtime data for an AI model. Specially, the data collection component 206 may include a model monitoring subcomponent 226 for monitoring the running AI model (or model runtime data 236) which may include monitoring and reporting model results associated with the AI model in different intervals (every 30 secs, or 1 min, etc.). Accordingly, the model runtime data 236 may include model name, timestamp data, and current model prediction results data. In turn, the data collection component 206 may further use data collection subcomponent 246 to collect the output data of each model including the timestamp data associated with each output, and then may store the output data in model history data store 266.

System identify component 208 may identify related sub-systems for a specified AI model as well as identify important subsystem that may be specifically important to the specified AI model. According to one embodiment, the specified AI model may include a model among the different AI models that is further selected for analysis and determination of trustworthiness. As previously described, each AI model may be monitored and analyzed in such a way. Accordingly, system identify component 208 may include a model relation selection subcomponent 218 which may find related subsystems and corresponding models for a specified AI model by using the model information previously described, including the features, categories, and subsystem data for an AI model, as well as finding related AI models using a chi-square test. Data construction subcomponent 238 may construct question-answer training and testing data for the specified AI model. Specifically, the data construction subcomponent 238 may use the features and collected output data (model results and model history data) of each related model from identified related subsystems according to the model relationship map to construct data and then divide the constructed data into question-answer training data 248 and question-answer testing data 258. Specifically, the question-answer training data 248 may be used to perform question-answer model training 268 of a question-answer model (M′) 278 for the specified AI model. More specifically, a purpose of the question-answer model M′ may be used to further identify/calculate an importance relationship between the specified AI model with a related subsystem (and corresponding AI models in the subsystem). Accordingly, for the related subsystems, the features and model results associated with the AI models in the subsystems (except for features and model results from the specified AI model if the specified AI model is in the subsystem) may be combined and considered as features for training the question answer model M′ 278. Accordingly, the question-answer model M′ 278 may be used to identify/calculate important subsystems and corresponding AI models of such subsystems to the specified AI model, and more specifically, to find high-related subsystems that are impacting the specified AI model and corresponding model results. In turn, system status identification and model improvement program 160 may use the question-answer model M′ 278 to identify a root cause of one or more discrepancies associated with the specified AI model, such as when the specified AI model prediction results may indicate a RED status for low accuracy or poor performance. Thus, when the specified AI model is determined to have a RED status, the system status identification and model improvement program 160 may be better at predicting which subsystem is impacting the specified AI model the most. In addition, when an identified important subsystem indicates a RED status, the system status identification and model improvement program 160 may determine that the specified AI model may be impacted.

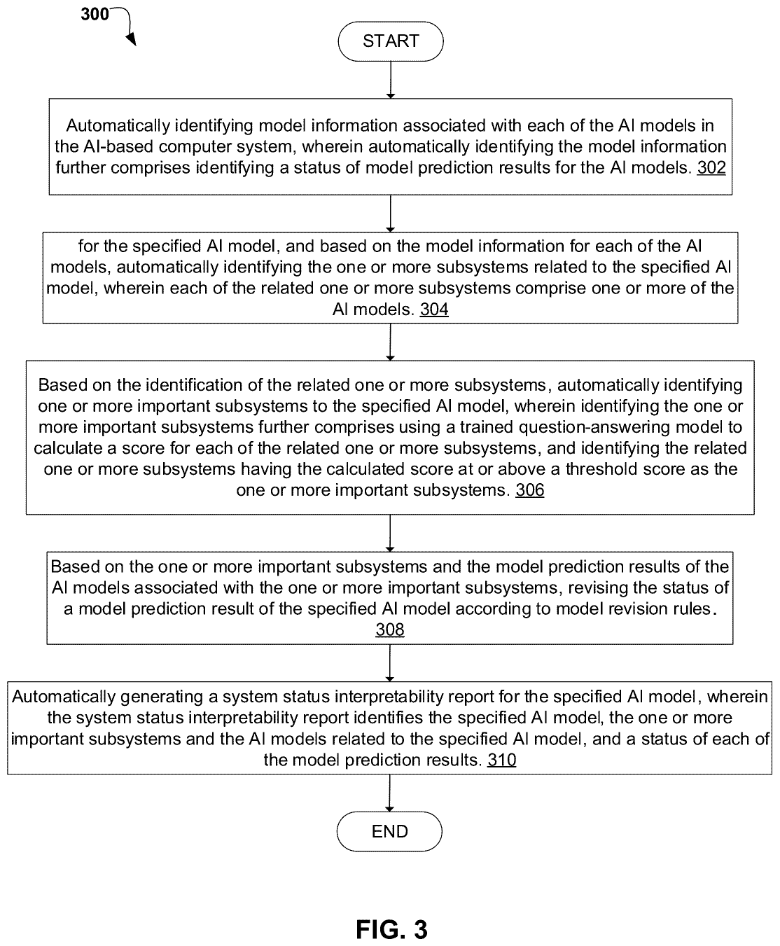

Also, in turn, subsystem identify subcomponent 288 may further be used to generate a subsystem importance table 298. Specifically, the system status identification and model improvement program 160 may use the trained question-answer model M′ to calculate an importance of each subsystem, whereby the importance may be determined/represented by a value which may further serve as a ranking of the importance of each subsystem. More specifically, subsystem identification subcomponent 288 may use the data and importance calculation received from the trained question-answer system model M′ 278 and the question-answer system testing data to identify the subsystem importance for each subsystem whose features are represented in the question-answer system test data set. A subsystem with higher importance, i.e. a higher calculated value, may mean the subsystem has more impact on the specified AI model. The identification and calculation of the important subsystems may be further described in FIGS. 3, 6, and 7.

The system status identification and model improvement program 160 may further include trustworthy analysis component 210. According to one embodiment, the trustworthy analysis component 210 may perform a real-time and continuous check on the runtime data (real-time model results) of the specified AI model, revise the status of the model results associated with the specified AI model according to one or more related subsystems to enhance model robustness and accuracy, and generate the system status interpretability report (SSIR) report 240 for the specified AI model to better interpret and provide updates on the system status. Thus, the trustworthy analysis component 210 may further include a trustworthy revise subcomponent 220 to ensure the trustworthiness of AI models by using an analysis of the model results associated with runtime data of a specified AI model to revise the status of a model result of the specified AI model which may be further based on detected inaccuracies in model results of a related and important subsystem. Furthermore, the trustworthy analysis component 210 may include a runtime analysis subcomponent 230 that uses the monitored model runtime data to detect and monitor the model runtime data and the revised model results and, in turn, generate the SSIR report for the specified AI model.

Referring now to FIG. 3, an operational flowchart 300 for a program for automatically enhancing/improving model robustness and accuracy associated with a specified artificial intelligence (AI) model among AI models in an AI-based computer system is depicted. Specifically, and as depicted at 302, the system status identification and model improvement program 160 may automatically identify model information associated with each of the AI models in the AI-based computer system, whereby automatically identifying the model information further includes identifying a status of model results for the AI models. More specifically, and as previously described with respect to FIG. 2, the system status identification and model improvement program 160 may include AI models 202 (M1 . . . . Mn), whereby each AI model may be associated with a subsystem within the AI-based computer system. As previously described, a specified AI model may include a model among the different AI models that is further selected for analysis and determination of trustworthiness. As previously described, each AI model may be monitored and analyzed in such a way. According to one embodiment, each subsystem may include different AI models, and each AI model may be tasked with managing, analyzing, and/or performing different computer tasks/operations in a computer system. For example, and among other potential AI models, an AI model may include a transaction delay status model which may manage computer transactions, a database (DB) health model which may manage the status and health of one or more databases, an input/output (IO) health model which may manage and perform input/output operations, etc.

Also, as previously described, the system status identification and model improvement program 160 may further include a model management component 204. The model management component 204 may identify and manage different AI models' information, features, and status. As further depicted in FIG. 2, the model management component 204 may include different subcomponents. For example, the model management component 204 may include a model collection subcomponent 214 for identifying model information associated with the AI models in the AI-based computer system, whereby the model information may include model configuration data 234 and testing data 224 for a respective AI model. For example, according to one embodiment, the model configuration data may include a model configuration file which may further include information on an AI model including the features used for training the model and other information that may assist in identifying related AI models for a model relation map.

For example, and with reference to FIG. 5, model information tables 500, and more specifically to model configuration files 502, a model configuration file may include model name, features, model category, and subsystem data. Model collection subcomponent 214 may also identify testing data 224 that may include test data used for testing a respective AI model, whereby the test data may also be used to identify and calculate feature importance. More specifically, feature identify subcomponent 244 may use the testing data 224 to calculate feature importance for each model and then may generate a model feature importance table 264 that includes the features and the calculated feature importance. The system status identification and model improvement program 160 may use known methods for calculating feature importance. As depicted in the model information tables 500 in FIG. 5, and specifically in feature importance table 504, the model configuration file may contain information on an AI model (M1), including model name, features, and feature importance.

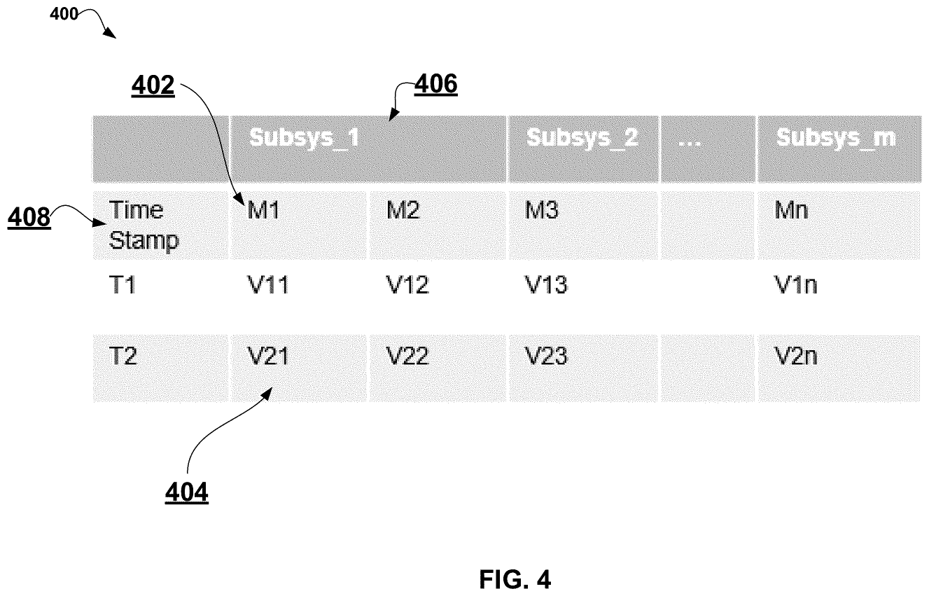

In turn, and with reference to AI model output table 400 in FIG. 4, the system status identification and model improvement program 160 may further identify each subsystem 406 and the AI models 402 associated with each subsystem 406 as well as identify model output data 404 (i.e. model results) associated with each of the AI models 402 including timestamp data 408. The system status identification and model improvement program 160 may also identify status information (not shown) associated with the model output data 404. As previously described, and using the system status identification and model improvement program 160, a subsystem's and/or model's results (model output data 404) may be analyzed and assigned a status, such as when the model results may be assigned a status of RED for indicating low accuracy and/or poor performance by a model, YELLOW for indicating a moderate accuracy and/or performance by the model, or GREEN for indicating a high accuracy and/or performance by a model. According to one embodiment, status indicators RED, YELLOW, and GREEN may further be based on a detection of inaccurate model results using machine learning.

For example, the system status identification and model improvement program 160 may use machine learning algorithms to determine an accuracy of a model result associated with an AI model. Accordingly, the system status identification and model improvement program 160 may also assign an AI model itself a RED status when at least 50% of model output data includes inaccurate model results according to the machine learning algorithms used to detect the accuracy of model results. Likewise, the system status identification and model improvement program 160 may assign an AI model a YELLOW status when at least 10-49% of model output data includes inaccurate model results. Furthermore, the system status identification and model improvement program 160 may assign an AI model a GREEN status when less than 10% of model output data includes inaccurate model results. Similarly, the system status identification and model improvement program 160 may determine a subsystem's status based on an amount AI models statuses indicating RED or YELLOW, whereby, among other example and potential status rules, the system status identification and model improvement program 160 may: assign a subsystem a RED status when at least 50% of the AI models include a RED status, assign a subsystem a YELLOW status when at least 10-49% of AI models include a RED status or greater than 50% of AI models include a YELLOW status, and assign a subsystem a GREEN status when less than 10% of the AI models include a RED and/or YELLOW status.

Then, at 304, for the specified AI model, and based on the model information for each of the AI models, the system status identification and model improvement program 160 may automatically identify the one or more subsystems related to the specified AI model, whereby each of the related one or more subsystems may include one or more of the AI models. As previously described with respect to FIG. 2, system identify component 208 may identify related sub-systems for a specified AI model, which may further include model relation selection subcomponent 218 and model relation map 228. Specifically, the model relation selection subcomponent 218 may identify related subsystems by identifying related AI models of a subsystem for a specified AI model using model information associated with each AI model as well as using a chi-square test.

More specifically, and according to one embodiment, the system status identification and model improvement program 160 may perform two steps to identify related AI models to the specified AI model. In a first step for the specified AI model, the system status identification and model improvement program 160 may determine whether other AI models in the system are part of a same category as the specified AI model, whereby an AI model may be considered related to the specified AI model if the category is the same. More specifically, and as previously described, the model management component 204 may further include model collection subcomponent 214 for identifying model information in the AI-based computer system, and more specifically, collecting model configuration and testing data for an AI model. As depicted in the model information tables 500 in FIG. 5, and more specifically in model configuration files 502, the model configuration file may contain information on an AI model, including model name, features, model category, and subsystem data. Accordingly, the system status identification and model improvement program 160 may identify an AI model (M2) with a same category (“SMS”) as the specified AI model (M1), and therefore, may determine that the AI models (M1, M2) are related and may add the related AI model (M2) to a model relation map 228 for the specified AI model (M1) and consequently the subsystem of model M2. In a second step, for AI models having a different category than the specified AI model, the system status identification and model improvement program 160 may use variables such as the model features, user definitions, and the model history data to identify related AI models to the specified AI model using a chi-square test. As generally known, the chi-square test is statistical test/calculation designed to test for a statistically significant relationship between nominal and ordinal variables (which may be organized in contingency tables) to determine whether two categorical variables (two dimensions of the contingency table) are independent in influencing the test statistic (values within the table). In turn, based on the chi-square test, the system status identification and model improvement program 160 may further identify and add related AI models and subsystems to the model relation map 228 for the specified AI model.

Next, 306, based on the identification of the related one or more subsystems, the system status identification and model improvement program 160 may automatically identify one or more important subsystems to the specified AI model, whereby identifying the one or more important subsystems further includes using a trained question-answering model to calculate a score for each of the related one or more subsystems, and identifying the related one or more subsystems having the calculated score at or above a threshold score as the one or more important subsystems. As previously described with respect to FIG. 2, data construction subcomponent 238 may construct question-answer training and testing data for the specified AI model. Specifically, the data construction subcomponent 238 may use the features and collected output data (model results and model history data) of each related model from identified related subsystems according to the model relationship map to construct data and then divide the constructed data into question-answer training data 248 and question-answer testing data 258. Specifically, the question-answer training data 248 may be used to perform question-answer model training 268 of a question-answer model (M′) 278 for the specified AI model. More specifically, a purpose of the question-answer model M′ may be used to further identify/calculate an importance relationship between the specified AI model with a related subsystem (and corresponding AI models in the subsystem). Accordingly, for the related subsystems, the features and model results associated with the AI models in the subsystems (except for features and model results from the specified AI model if the specified AI model is in the subsystem) may be combined and considered as features for training the question answer model M′ 278. Accordingly, the trained question-answer model M′ 278 may be used to identify/calculate important subsystems and corresponding AI models of such subsystems to the specified AI model, and more specifically, to find high-related subsystems that are impacting the specified AI model and corresponding model results.

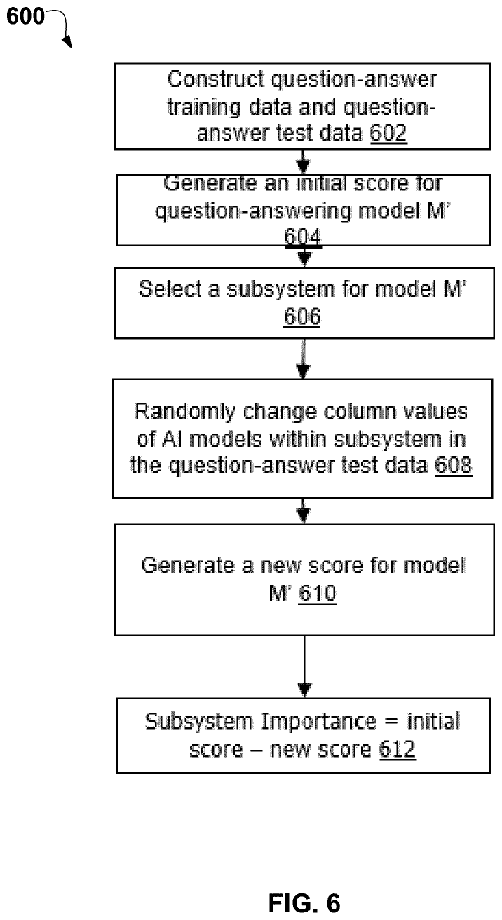

According to one embodiment and using the trained question-answer model M′ 278, the system status identification and model improvement program 160 may use the operational flowchart 600 in FIG. 6 to calculate, identify, and rank subsystems of importance to the specified AI model. Specifically, at 602, the data construction subcomponent may use the features and collected model output data of each related model from related subsystems (including timestamp data and model history data) to construct data according to the model relationship map and divide the constructed data into question-answer training data and question-answer testing data. Thereafter, at 604, the system status identification and model improvement program 160 may use the question-answer testing dataset to generate a score for the question-answering model (M′). Specifically, according to one embodiment, the system status identification and model improvement program 160 may use the question-answer testing data to test the question-answering model (M′), and based on the testing, may determine a model accuracy score and use the model accuracy score as an initial score for the question-answering model (M′). Thereafter, at 606, the system status identification and model improvement program 160 may select a specified subsystem among the subsystems included in the question answer testing data and associated with the question-answering model (M′). Next, at 608, the system status identification and model improvement program 160 may randomly change selected values of the AI models belonging to the specified subsystem (i.e. change values in different columns of the AI models) that, in turn, creates a new question-answer testing dataset. Then, at 610, the system status identification and model improvement program 160 may use the new question-answer testing dataset to get a new score for the question-answer model M′. Then, at 612, the system status identification and model improvement program 160 may calculate a value representing subsystem importance for the specified subsystem by taking the initial score minus the new score for the question-answer model M′. The system status identification and model improvement program 160 may repeat steps 606-612 for each related subsystem to determine a score for each related subsystem.

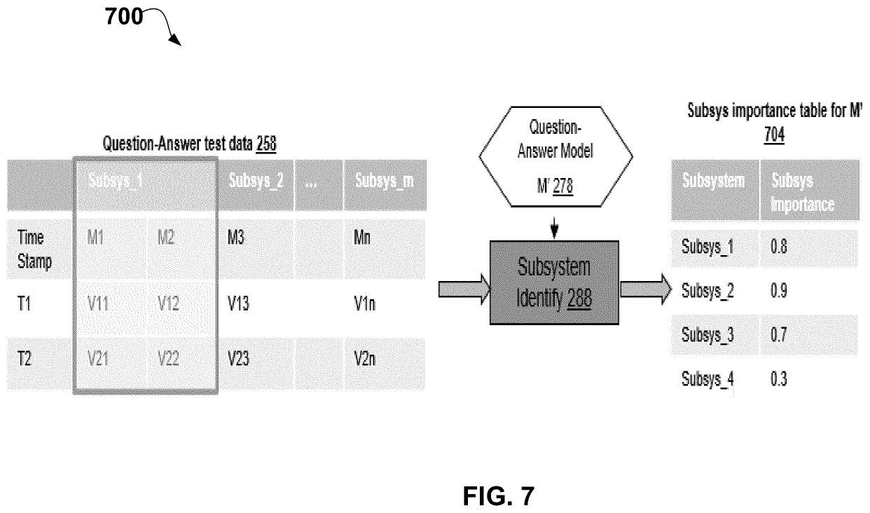

As depicted in FIG. 7, which includes an illustration of a flowchart 700 for generating a subsystem importance table 702, the system status identification and model improvement program 160 may further use the subsystem identification subcomponent 288 to generate a subsystem importance table 702 as depicted in FIG. 7. As previously described with respect to FIG. 2, the subsystem identification subcomponent 288 may use test data and an importance calculation from the question-answer system testing data 258 and the trained question-answer system model M′ 278, respectively, to identify the subsystem importance for each related subsystem and may generate a subsystem importance table 704. According to one embodiment, a subsystem with a higher importance, i.e. a higher calculated threshold score/value, may mean that the subsystem has a greater impact on the specified AI model. More specifically, a subsystem with a certain threshold score maybe designated as important for the specified AI model. For instance, in FIG. 7 and as depicted in the subsystem importance table 704, the system status identification and model improvement program 160 may be configured such that related subsystems having a score equal to or above a score of 0.7 may be designated as important subsystems. Therefore, in turn, subsystems, Subsys_1, Subsys_2, and Subsys_3, may designated as important subsystems.

Thereafter, at 308, based on the one or more important subsystems and the model prediction results of the AI models associated with the one or more important subsystems, the system status identification and model improvement program 160 may revise the status of a model result of the specified AI model according to model revision rules. As previously described with respect to FIG. 2 and according to one embodiment, the trustworthy analysis component 210 may perform a real-time and continuous check on the runtime (real-time) data of the specified AI model, revise the status of model results associated with the specified AI model according to one or more related subsystems to enhance model robustness and accuracy, and generate the system status interpretability report (SSIR) report 240 for the specified AI model to better interpret system status. Thus, the trustworthy analysis component 210 may further include a trustworthy revise subcomponent 220 that uses the model results associated with runtime data to revise the status of a model result of the specified AI model. Furthermore, the trustworthy analysis component 210 may include a runtime analysis subcomponent 230 that uses the monitored model runtime data to detect and monitor model runtime data including the number of revised model result statuses and, in turn, generate the SSIR report for the specified AI model.

More specifically, the system status identification and model improvement program 160 may perform the following steps in using the trustworthy revise subcomponent 220 to revise a status of a model result of the specified AI model (M):
1. Identify the subsystem name of top N importance in the subsystem importance table, wherein N represents the number of subsystems having a certain threshold score/value of importance.
2. Each subsystem may have multiple AI models, therefore, get all model names from model relation map for all selected subsystems.
3. Check the status of the selected AI models, status could be GREEN, YELLOW, RED. Compute the percentage P of each type, including computing P (green)=(Number of Green Models)/(total number of models), computing P (yellow)=(Number of Yellow Models)/(total number of models), computing P (red)=(Number of Red Models)/(total number of models).
4. Check status of a model result of the specified AI model (M), and mark model result status as F (M). Define two thresholds, T (low) and T (high), and a counter R to record number of revised model result statuses, where T (High) is a high threshold that triggers a revise of a current model result status of model M from GREEN to RED or RED to YELLOW, and T (Low) is a threshold to trigger the revise of a current model result status for model M from YELLOW to RED. Then, revise results associated with the specified AI model further according to the following model revision rules:
   If F (M)=GREEN, P (red) over a threshold T (high), then set F (M)=RED, R=R+1
   If F (M)=YELLOW, P (red) over a threshold T (low), then set F (M)=RED, R=R+1
   If F (M)=RED, P (green) over a threshold T (high), then set F (M)=YELLOW, R=R+1
5. Check the revise ratio by interval, revise ratio is R/(number of results for model M in an interval), if the revise ratio over a threshold, then retrain the model M.

In reference to the model revision rules described above, the system status identification and model improvement program 160 may revise a model result status of the specified AI model (M). For example, the system status identification and model improvement program 160 may select the subsystem names of top N importance in the subsystem importance table previously described. Each subsystem may have multiple models, therefore, the system status identification and model improvement program 160 may retrieve all model names belonging to the subsystems.

In an example, the P (green) is the percentage of GREEN in the selected AI models. Thus, for instance, if there are a total of 100 models selected, and 60 models are currently with GREEN prediction result, the P (green) is 60%. P (red) and P (yellow) may be represented in the same way.

As described above, F (M) is the current prediction value status (model result status) of the specified AI model (M).

Also, as described above, T (High) is a high threshold that triggers a revise of a current model result status of the specified AI model (M) from GREEN to RED or RED to YELLOW. For example, in setting T (high)=80%, if current prediction F (M) is GREEN, but P (red) is 90%, which means 90% of related important models are currently RED, then the system status identification and model improvement program 160 may revise the model prediction status (or model result status) of model M from GREEN to RED.

As also described above, T (Low) is a threshold to trigger the revise of model M from YELLOW to RED. For example, if T (low)=50%, currently F (M) is yellow, and P (red) is 60%, then the system status identification and model improvement program 160 may revise the model prediction status of the specified AI model (M) from YELLOW to RED.

The R is a counter that is used to record the number of revisions for the specified AI model (M) in an interval. The R=R+1 means that when there is a revision, the counter should be added by one. For example, if currently R=20 and there is another revision of (M) from GREEN to RED, then R will set to 21.

The revise ratio is the percentage of revision in an interval, it is R/(the number of results for M in this interval). For example, the interval may be 24 hours, and in the 24 hours the specified AI model (M) may run 1000 prediction, and there may be 200 revision of model prediction result statuses, which R=200, then the revise ratio is 200/1000 which is 20%. If the revise ratio is too high (which may be defined by a threshold percentage such as equal to or above 50%), meaning that the current model (M) predictions are not precise, then the system status identification and model improvement program 160 may retrain the specified AI model (M).

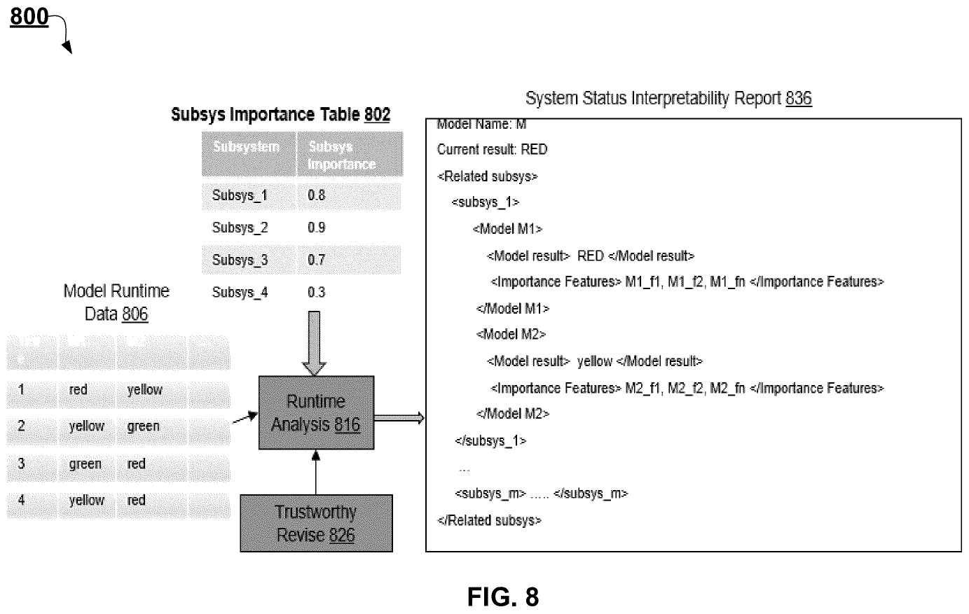

Then, at 310, and as depicted in FIG. 8, the system status identification and model improvement program 160 may generate a system status interpretability report 836 for the specified AI model, whereby the system status interpretability report 836 identifies the specified AI model, the one or more subsystems and the AI models related to the specified AI model, a first status associated with the model results of the specified AI model, and one or more second statuses associated with the model results from the AI models of subsystems related to the specified AI model. As previously described with respect to FIG. 2 and now depicted in FIG. 8 in operational flowchart diagram 800, the system status identification and model improvement program 160 may include a trustworthy revise subcomponent 826 to ensure the trustworthiness of AI models by using machine learning to evaluate model results associated with model runtime data 806 of a specified AI model to revise the status of a model result of the specified AI model based on detected statuses in model results of a related and important subsystem as depicted in subsystem importance table 802. Furthermore, and as previously described with respect to FIG. 2 and now depicted in FIG. 8, the system status identification and model improvement program 160 may include a runtime analysis subcomponent 816 that uses the monitored model runtime data to detect and monitor the model runtime data and the revised model results and, in turn, generate the SSIR report 836 for the specified AI model. As previously described, the system status interpretability report 836 may identify the specified AI model, the one or more subsystems and the AI models related to the specified AI model, a first status associated with the specified AI model, and one or more second statuses associated with model results from the AI models related to the specified AI model. The system status interpretability report 836 may further model names and features associated with and used to train the AI models.

It may be appreciated that FIGS. 2-8 provide only illustrations of one implementation and does not imply any limitations with regard to how different embodiments may be implemented. Many modifications to the depicted environments may be made based on design and implementation requirements.

The present subject matter may comprise the following clauses.

Clause 1. A computed-implemented method for automatically determining a root cause of one or more discrepancies associated with a specified AI model among AI models in a model-based computer system, comprising: automatically identifying model information associated with each of the AI models in the AI-based computer system, wherein automatically identifying the model information further comprises identifying a status of model results for the AI models; automatically identifying the one or more subsystems related to the specified AI model, wherein each of the related one or more subsystems comprise one or more of the AI models; based on the identification of the related one or more subsystems, automatically identifying one or more important subsystems to the specified AI model, wherein automatically identifying the one or more important subsystems further comprises using a trained question-answering model to calculate a score for each of the related one or more subsystems, and identifying the related one or more subsystems having the calculated score at or above a threshold score as the one or more important subsystems; based on the one or more important subsystems and the model results of the AI models associated with the one or more important subsystems, automatically revising the status of a model result of the specified AI model according to model revision rules; and generate a system status interpretability report for the specified AI model.

Clause 2. The computed-implemented method of clause 1, further comprising: retraining the specified AI model based on the model revision rules.

Clause 3. The computed-implemented method of any of the preceding clauses 1 to 2, wherein identifying the model information further includes identifying model configuration data that includes features used in training and testing a respective AI model from the AI models, and identifying model name, category data, and subsystem data.

Clause 4. The computed-implemented method of any of the preceding clauses 1 to 3, wherein automatically identifying the related one or more subsystems further comprises: automatically determining whether a given AI model from the AI models in the AI-based computer system is associated with a same category as the specified AI model; in response to determining that the given AI model is associated with the same category as the specified AI model, determining that the given AI model is related to the specified AI model and adding the given AI model to a model relation map; in response to determining that the given AI model is not associated with the same category as the specified AI model, determining whether the given AI model is related to the specified AI model using a chi-square test.

Clause 5. The computed-implemented method of any of the preceding clauses 1 to 4, wherein using the trained question-answering model to calculate a score for each of the related one or more subsystems further comprises: using the model information of each related AI model associated with the one or more subsystems to construct data into a question-answer training data and a question-answer testing data; using the question-answer training data to train the question-answering model; using the question-answer testing data to get an initial score for the question-answering model; selecting a subsystem associated with the question-answering model; randomly changing column values within AI models of the selected subsystem to generate a new question-answer testing data; using the new question-answer test data to generate a new score for the question-answering model; and calculating a value representing subsystem importance for the selected subsystem based on a difference between the initial score and the new score.

Clause 6. The computed-implemented method of any of the preceding clauses 1 to 5, wherein automatically revising the status of the model result of the specified AI model according to the model revision rules further comprises: automatically revising the model result based on a percentage of the model results associated with the one or more important subsystems indicating inaccuracies.

Clause 7. The computed-implemented method of any of the preceding clauses 1 to 6, wherein the system status interpretability report further identifies the specified AI model, the one or more subsystems and the AI models related to the specified AI model, and the status associated with the model results of the specified AI model and the AI models of the related one or more subsystems.

Clause 8. A computed system comprising one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising: automatically identifying model information associated with each of the AI models in the AI-based computer system, wherein automatically identifying the model information further comprises identifying a status of model results for the AI models; automatically identifying the one or more subsystems related to the specified AI model, wherein each of the related one or more subsystems comprise one or more of the AI models; based on the identification of the related one or more subsystems, automatically identifying one or more important subsystems to the specified AI model, wherein automatically identifying the one or more important subsystems further comprises using a trained question-answering model to calculate a score for each of the related one or more subsystems, and identifying the related one or more subsystems having the calculated score at or above a threshold score as the one or more important subsystems; based on the one or more important subsystems and the model results of the AI models associated with the one or more important subsystems, automatically revising the status of a model result of the specified AI model according to model revision rules; and generate a system status interpretability report for the specified AI model.

Clause 9. The computed system of clause 8, further comprising: retraining the specified AI model based on the model revision rules.

Clause 10. The computed system of any of the preceding clauses 8 to 9, wherein identifying the model information further includes identifying model configuration data that includes features used in training and testing a respective AI model from the AI models, and identifying model name, category data, and subsystem data.

Clause 11. The computed system of any of the preceding clauses 8 to 10, wherein automatically identifying the related one or more subsystems further comprises: automatically determining whether a given AI model from the AI models in the AI-based computer system is associated with a same category as the specified AI model; in response to determining that the given AI model is associated with the same category as the specified AI model, determining that the given AI model is related to the specified AI model and adding the given AI model to a model relation map; in response to determining that the given AI model is not associated with the same category as the specified AI model, determining whether the given AI model is related to the specified AI model using a chi-square test.

Clause 12. The computed system of any of the preceding clauses 8 to 11, wherein using the trained question-answering model to calculate a score for each of the related one or more subsystems further comprises: using the model information of each related AI model associated with the one or more subsystems to construct data into a question-answer training data and a question-answer testing data; using the question-answer training data to train the question-answering model; using the question-answer testing data to get an initial score for the question-answering model; selecting a subsystem associated with the question-answering model; randomly changing column values within AI models of the selected subsystem to generate a new question-answer testing data; using the new question-answer test data to generate a new score for the question-answering model; and calculating a value representing subsystem importance for the selected subsystem based on a difference between the initial score and the new score.

Clause 13. The computed system of any of the preceding clauses 8 to 12, wherein automatically revising the status of the model result of the specified AI model according to the model revision rules further comprises: automatically revising the model result based on a percentage of the model results associated with the one or more important subsystems indicating inaccuracies.

Clause 14. The computed system of any of the preceding clauses 8 to 13, wherein the system status interpretability report further identifies the specified AI model, the one or more subsystems and the AI models related to the specified AI model, and the status associated with the model results of the specified AI model and the AI models of the related one or more subsystems.

Clause 15. A computer program product comprising one or more tangible computer-readable storage devices and program instructions stored on at least one of the one or more tangible computer-readable storage devices, the program instructions executable by a processor, the program instructions comprising: automatically identifying model information associated with each of the AI models in the AI-based computer system, wherein automatically identifying the model information further comprises identifying a status of model results for the AI models; automatically identifying the one or more subsystems related to the specified AI model, wherein each of the related one or more subsystems comprise one or more of the AI models; based on the identification of the related one or more subsystems, automatically identifying one or more important subsystems to the specified AI model, wherein automatically identifying the one or more important subsystems further comprises using a trained question-answering model to calculate a score for each of the related one or more subsystems, and identifying the related one or more subsystems having the calculated score at or above a threshold score as the one or more important subsystems; based on the one or more important subsystems and the model results of the AI models associated with the one or more important subsystems, automatically revising the status of a model result of the specified AI model according to model revision rules; and generate a system status interpretability report for the specified AI model.

Clause 16. The computer program product of clause 15, further comprising: retraining the specified AI model based on the model revision rules.

Clause 17. The computer program product of any of the preceding clauses 15 to 16, wherein identifying the model information further includes identifying model configuration data that includes features used in training and testing a respective AI model from the AI models, and identifying model name, category data, and subsystem data.

Clause 18. The computer program product of any of the preceding clauses 15 to 17, wherein automatically identifying the related one or more subsystems further comprises: automatically determining whether a given AI model from the AI models in the AI-based computer system is associated with a same category as the specified AI model; in response to determining that the given AI model is associated with the same category as the specified AI model, determining that the given AI model is related to the specified AI model and adding the given AI model to a model relation map; in response to determining that the given AI model is not associated with the same category as the specified AI model, determining whether the given AI model is related to the specified AI model using a chi-square test.

Clause 19. The computer program product of any of the preceding clauses 15 to 18, wherein using the trained question-answering model to calculate a score for each of the related one or more subsystems further comprises: using the model information of each related AI model associated with the one or more subsystems to construct data into a question-answer training data and a question-answer testing data; using the question-answer training data to train the question-answering model; using the question-answer testing data to get an initial score for the question-answering model; selecting a subsystem associated with the question-answering model; randomly changing column values within AI models of the selected subsystem to generate a new question-answer testing data; using the new question-answer test data to generate a new score for the question-answering model; and calculating a value representing subsystem importance for the selected subsystem based on a difference between the initial score and the new score.

Clause 20. The computer program product of any of the preceding clauses 15 to 19, wherein automatically revising the status of the model result of the specified AI model according to the model revision rules further comprises: automatically revising the model result based on a percentage of the model results associated with the one or more important subsystems indicating inaccuracies.

As previously described, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Furthermore, machine learning as described herein may broadly refer to machine learning algorithms that learn from data. More specifically, machine learning is a branch of artificial intelligence that relates to algorithms such as mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusters, such as k-means clusters, mean-shift clusters, and spectral clusters; (v) factorization machines, principal component analyzers and kernel principal component analyzers; and (vi) ensembles or other combinations of machine-learning models. Neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

What is claimed is:

1. A computer-implemented method for automatically enhancing model robustness and accuracy associated with a specified artificial intelligence (AI) model among AI models in an AI-based computer system, the computer-implemented method comprising:
automatically identifying model information associated with each of the AI models in the AI-based computer system, wherein automatically identifying the model information further comprises identifying a status of model results for the AI models;
automatically identifying the one or more subsystems related to the specified AI model, wherein each of the related one or more subsystems comprise one or more of the AI models;
based on the identification of the related one or more subsystems, automatically identifying one or more important subsystems to the specified AI model, wherein automatically identifying the one or more important subsystems further comprises using a trained question-answering model to calculate a score for each of the related one or more subsystems, and identifying the related one or more subsystems having the calculated score at or above a threshold score as the one or more important subsystems;
based on the one or more important subsystems and the model results of the AI models associated with the one or more important subsystems, automatically revising the status of a model result of the specified AI model according to model revision rules; and
generating a system status interpretability report for the specified AI model.

2. The computer-implemented method of claim 1, further comprising:
retraining the specified AI model based on the model revision rules.

3. The computer-implemented method of claim 1, whereby identifying the model information further includes identifying model configuration data that includes features used in training and testing a respective AI model from the AI models, and identifying model name, category data, and subsystem data.

4. The computer-implemented method of claim 1, wherein automatically identifying the related one or more subsystems further comprises:
automatically determining whether a given AI model from the AI models in the AI-based computer system is associated with a same category as the specified AI model;
in response to determining that the given AI model is associated with the same category as the specified AI model, determining that the given AI model is related to the specified AI model and adding the given AI model to a model relation map;
in response to determining that the given AI model is not associated with the same category as the specified AI model, determining whether the given AI model is related to the specified AI model using a chi-square test.

5. The computer-implemented method of claim 1, wherein using the trained question-answering model to calculate a score for each of the related one or more subsystems further comprises:
using the model information of each related AI model associated with the one or more subsystems to construct data into a question-answer training data and a question-answer testing data;
using the question-answer training data to train the question-answering model;
using the question-answer testing data to get an initial score for the question-answering model;
selecting a subsystem associated with the question-answering model;
randomly changing column values within AI models of the selected subsystem to generate a new question-answer testing data;
using the new question-answer test data to generate a new score for the question-answering model; and
calculating a value representing subsystem importance for the selected subsystem based on a difference between the initial score and the new score.

6. The computer-implemented method of claim 1, wherein automatically revising the status of the model result of the specified AI model according to the model revision rules further comprises:
automatically revising the model result based on a percentage of the model results associated with the one or more important subsystems indicating inaccuracies.

7. The computer-implemented method of claim 1, wherein the system status interpretability report further identifies the specified AI model, the one or more subsystems and the AI models related to the specified AI model, and the status associated with the model results of the specified AI model and the AI models of the related one or more subsystems.

8. A computer system for automatically enhancing model robustness and accuracy associated with a specified artificial intelligence (AI) model among AI models in an AI-based computer system, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
automatically identifying model information associated with each of the AI models in the AI-based computer system, wherein automatically identifying the model information further comprises identifying a status of model results for the AI models;
automatically identifying the one or more subsystems related to the specified AI model, wherein each of the related one or more subsystems comprise one or more of the AI models;
based on the identification of the related one or more subsystems, automatically identifying one or more important subsystems to the specified AI model, wherein automatically identifying the one or more important subsystems further comprises using a trained question-answering model to calculate a score for each of the related one or more subsystems, and identifying the related one or more subsystems having the calculated score at or above a threshold score as the one or more important subsystems;
based on the one or more important subsystems and the model results of the AI models associated with the one or more important subsystems, automatically revising the status of a model result of the specified AI model according to model revision rules; and
generating a system status interpretability report for the specified AI model.

9. The computer system of claim 8, further comprising:
retraining the specified AI model based on the model revision rules.

10. The computer system of claim 8, whereby identifying the model information further includes identifying model configuration data that includes features used in training and testing a respective AI model from the AI models, and identifying model name, category data, and subsystem data.

11. The computer system of claim 8, wherein automatically identifying the related one or more subsystems further comprises:
automatically determining whether a given AI model from the AI models in the AI-based computer system is associated with a same category as the specified AI model;
in response to determining that the given AI model is associated with the same category as the specified AI model, determining that the given AI model is related to the specified AI model and adding the given AI model to a model relation map;
in response to determining that the given AI model is not associated with the same category as the specified AI model, determining whether the given AI model is related to the specified AI model using a chi-square test.

12. The computer system of claim 8, wherein using the trained question-answering model to calculate a score for each of the related one or more subsystems further comprises:
using the model information of each related AI model associated with the one or more subsystems to construct data into a question-answer training data and a question-answer testing data;
using the question-answer training data to train the question-answering model;
using the question-answer testing data to get an initial score for the question-answering model;
selecting a subsystem associated with the question-answering model;
randomly changing column values within AI models of the selected subsystem to generate a new question-answer testing data;
using the new question-answer test data to generate a new score for the question-answering model; and
calculating a value representing subsystem importance for the selected subsystem based on a difference between the initial score and the new score.

13. The computer system of claim 8, wherein automatically revising the status of the model result of the specified AI model according to the model revision rules further comprises:
automatically revising the model result based on a percentage of the model results associated with the one or more important subsystems indicating inaccuracies.

14. The computer system of claim 8, wherein the system status interpretability report further identifies the specified AI model, the one or more subsystems and the AI models related to the specified AI model, and the status associated with the model results of the specified AI model and the AI models of the related one or more subsystems.

15. A computer program product for automatically enhancing model robustness and accuracy associated with a specified artificial intelligence (AI) model among AI models in an AI-based computer system, comprising:
one or more tangible computer-readable storage devices and program instructions stored on at least one of the one or more tangible computer-readable storage devices, the program instructions executable by a processor, the program instructions comprising:
automatically identifying model information associated with each of the AI models in the AI-based computer system, wherein automatically identifying the model information further comprises identifying a status of model results for the AI models;
automatically identifying the one or more subsystems related to the specified AI model, wherein each of the related one or more subsystems comprise one or more of the AI models;
based on the identification of the related one or more subsystems, automatically identifying one or more important subsystems to the specified AI model, wherein automatically identifying the one or more important subsystems further comprises using a trained question-answering model to calculate a score for each of the related one or more subsystems, and identifying the related one or more subsystems having the calculated score at or above a threshold score as the one or more important subsystems;
based on the one or more important subsystems and the model results of the AI models associated with the one or more important subsystems, automatically revising the status of a model result of the specified AI model according to model revision rules; and
generating a system status interpretability report for the specified AI model.

16. The computer program product of claim 15, further comprising:
retraining the specified AI model based on the model revision rules.

17. The computer program product of claim 15, whereby identifying the model information further includes identifying model configuration data that includes features used in training and testing a respective AI model from the AI models, and identifying model name, category data, and subsystem data.

18. The computer program product of claim 15, wherein automatically identifying the related one or more subsystems further comprises:
automatically determining whether a given AI model from the AI models in the AI-based computer system is associated with a same category as the specified AI model;
in response to determining that the given AI model is associated with the same category as the specified AI model, determining that the given AI model is related to the specified AI model and adding the given AI model to a model relation map;
in response to determining that the given AI model is not associated with the same category as the specified AI model, determining whether the given AI model is related to the specified AI model using a chi-square test.

19. The computer program product of claim 15, wherein using the trained question-answering model to calculate a score for each of the related one or more subsystems further comprises:
using the model information of each related AI model associated with the one or more subsystems to construct data into a question-answer training data and a question-answer testing data;
using the question-answer training data to train the question-answering model;
using the question-answer testing data to get an initial score for the question-answering model;
selecting a subsystem associated with the question-answering model;
randomly changing column values within AI models of the selected subsystem to generate a new question-answer testing data;
using the new question-answer test data to generate a new score for the question-answering model; and
calculating a value representing subsystem importance for the selected subsystem based on a difference between the initial score and the new score.

20. The computer program product of claim 15, wherein automatically revising the status of the model result of the specified AI model according to the model revision rules further comprises:
automatically revising the model result based on a percentage of the model results associated with the one or more important subsystems indicating inaccuracies.
